(19) United States
(12) Patent Application Publication
(10) Pub. No.: US 2005/0012246 A1
(43) Pub. Date: Jan. 20, 2005

(54) High resolution and rapid three dimensional object generator

(76) Inventor: Kazutora Yoshino, Eden Prairie, MN (US)

Correspondence Address: Kazutora Yoshino, 7227 Divinity Lane, Eden Prairie, MN, 55346, US

(21) Appl. No.: 10/600,002

(22) Filed: Jun. 19, 2003

(51) Int. Cl. G06F 19/00; B29C 35/04

(52) U.S. Cl. 264/401; 700/120

(57) ABSTRACT

The device makes 3 dimensional objects. Micro-displays with quick reactant of material enable to produce the 3 dimensional objects very rapidly and with high resolution. Optionally, the 3 dimensional input device is embedded to the system to create the instant duplication of 3 dimensional images/objects. Image can be artificially generated by CAD model. Imaged beams are projected to the materials. The materials react with imaged beams and are hardened, softened or cut according to the desired shape generated by the imaged beam. Image can be projected to the surface of material or inside of the material to generate 3 dimensional object.

### FEDERALLY SPONSORED RESEARCH

Not Applicable

### SEQUENCE LISTING OR PROGRAM

Not Applicable

### BACKGROUND OF INVENTION

### FIELD OF INVENTION

The field is to make rapid prototypes of 3 dimensional structures using various materials.

### PRIOR ART

U.S. Pat. No. 6,504,127 “Laser consolidation methodology and apparatus for manufacturing precise structures” by MaGregor, et al. at Jan. 7, 2003 for cutting material to make 3 D structure using laser scanner. But this method is not fast enough for recent applications.

### BACK GROUND OF INVENTION

It is important to make 3 dimensional model & object quickly. One of the reasons is that people like engineers can examine what they are designing. Also, one can input 3 dimensional object and duplicate with the same or various sizes, materials, colors. There are some 3 dimensional object making machines but they are still not fast enough and not high resolution enough for certain applications such as instant prototyping.

### SUMMARY

In order to overcome the speed and resolution of conventional 3 dimensional prototyping, we uses the fast image projecting system with fast reactant for the beam projection. First, recent development of the micro-displays is one of factors for us to create 3 dimensional object generator with the fast resolution and high resolution. Second, recent development of materials quick reactant to beams such as photons (microwave range, ultraviolet, visual range, infrared, etc.), electron beam, ultrasound beam, etc. are another factor to let us to produce 3 dimensional object generator. The materials can be reacted chemically, hardened, softened or cut by the energy of the beam (like laser beam). Third, the development of the 3 dimensional image/object input device are incredible, like scanning system SONY entertainment vision, Minolta vivid 300, LDI, CGI have quick and high resolution 3 dimensional input devices. Fourth, of course, the computer speed of recent year has been increasing a lot which enable us to make the system much faster as well. The way how this system works is to project beams with images to material means that react with those beam. By controlling the image and material with fast computers, one can make 3 dimensional object quickly. Optionally, the 3 dimensional input device to get the 3 dimensional image/object data can be added. Optionally, the relative distance between object and projector can be controlled by base height/position controller or by projector height/position controller. For example, add a layer of liquid chemical source and use blue light to harden the chemical, adjust height of surface to proper position, and add a layer to repeat to create 3D object by adding sliced figures of object.

### FIGURES

FIG. 1 shows the example diagram of the concept of 3 dimensional object generator

FIG. 2 shows the alternative example diagram of the 3 dimensional object generator

FIG. 3 shows the example method how to develop the layers of 3 dimensional object

FIG. 4 shows the example connection to the 3 dimensional image/object input device

FIG. 5 shows the example diagram of matrix light unit that can be used as the micro-display

### DETAILED EXPLANATION OF FIGURES

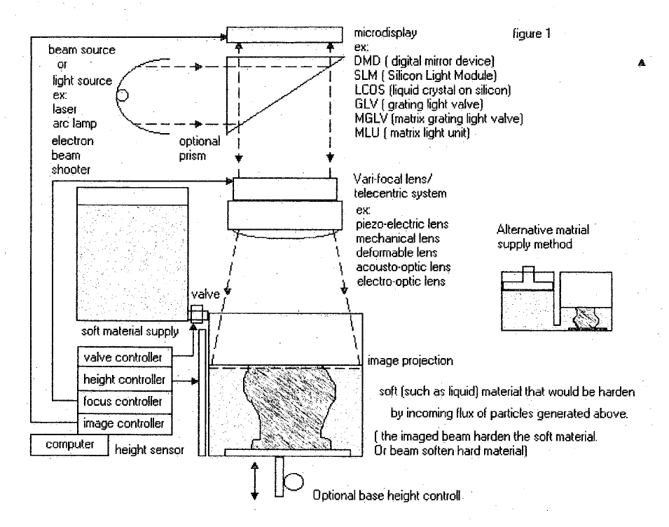

FIG. 1 shows the example diagram of the concept of 3 dimensional object generator. This one shows the beam sources such as arc lamp, laser, electron beam source, microwave, etc. are projected to micro-display system and projected to material that react to such beams. The material can be hardened or softened depending on the application. Optionally, the height of the material can be controlled. Also, optionally, the vari-focal/tele-centric method can be used to create the sharp images on the surface or inside of the material to create 3 dimensional object.

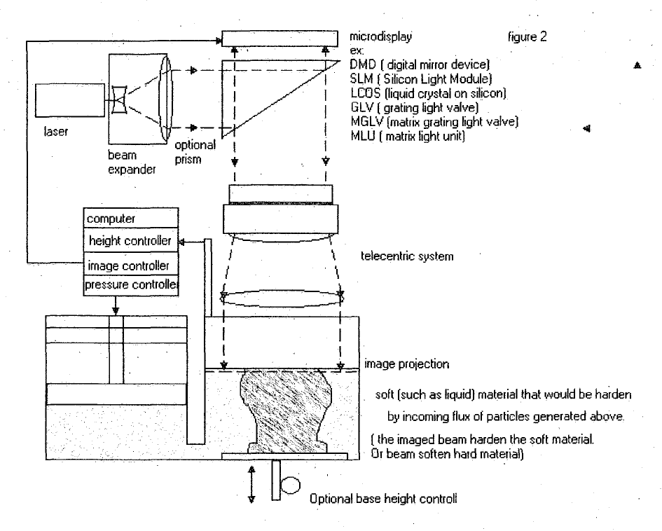

FIG. 2 shows the alternative example diagram of the 3 dimensional object generator. Laser beam is used and tele-centric method (parallel beam) is chosen here. Also this shows the alternative method of material supply if the supply material is soft (liquid).

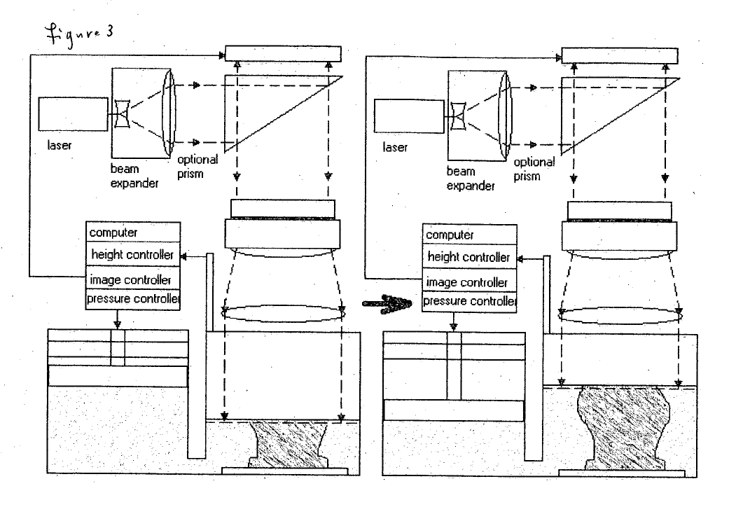

FIG. 3 shows the example method how to develop the layers of 3 dimensional object. The image can be projected to each surface of material from bottom. (The base can be placed at first.) After the material is harden or soften, the system raises the level to go to next layer. By repeating this, one can achieve to make 3 dimensional object. It can be done directly inside of material by having focus to right layers as well.

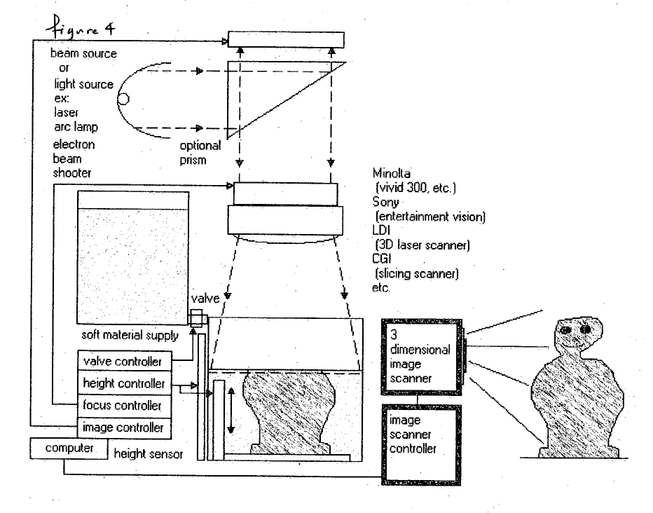

FIG. 4 shows the example connection to the 3 dimensional image/object input device. The implantation of 3 dimensional image/object input device enable to input the 3 dimensional image/object and output (duplicate) the 3 dimensional object in such a short time.

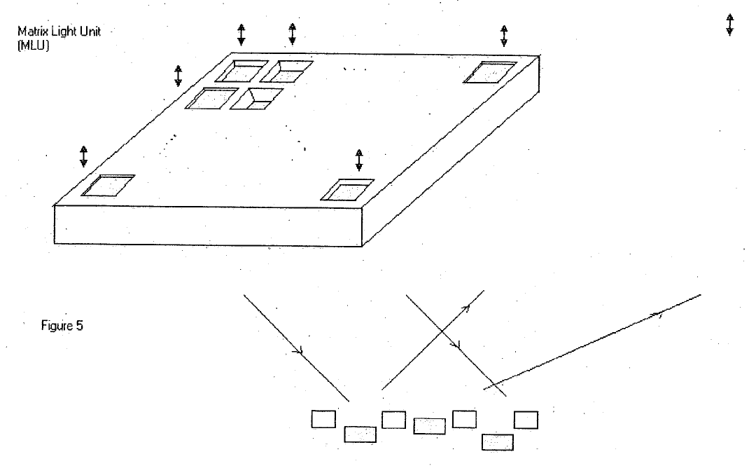

FIG. 5 shows the example diagram of matrix light unit that can be used as the micro-display. Each small unit changes the location (height and/or angle) to create the deflect light in multiple dimension. It can be made in silicon, but can be other material as well. The response time is so short that images can be generated very quickly. This can be used for various applications such as 3 dimensional display (projector), 3 dimensional object generator.

1. The three dimensional object generator composed of the group selected from
1) Beam projector means
2) Beam navigator means
3) Image generator means
4) Material supply system means
5) Controller means
6) Optionally, input device means
7) Optionally, vari-focal lens means
8) Optionally, object-projector position controller means

2. the claim of 1, wherein said Beam projector means is composed of the group selected from photon generator, electron generator, particles generator, ion generator, laser, arc lamp, visible light, ultra violet light, infrared light, microwave, ultrasound

3. the claim of 1, wherein said Beam navigtor means is composed of the group selected from proper combination of lenses, tele-centric lens system, vari-focal lens system, magnetic lens system, optical lens system, reflector, lens-less beam navigator system

4. the claim of 1, wherein said Image generator means is composed of the group selected from micro-display, photo-display, pattern generator, digital mirror device, liquid crystal, liquid crystal on silicon, grating light valve, matrix grating light valve, matrix light unit.

5. the claim of 1, wherein said Material supply system means is composed of the group selected from liquid plastic, metal, plastic, liquid material, solid material, gas material, photo-sensitive material, electron-sensitive material, materials that react with beams

6. the claim of 1, wherein said controller means is composed of the group selected from material supply controller, image controller, height controller, valve controller, input image controller, computer, drivers

7. the claim of 1, wherein the said Input device means is composed of the group selected from triangular 3 dimensional image input devices, mesh-oriented 3 dimensional image input device, the slicing type 3 dimensional image input devices, multi-eyes 3 dimensional image input device, single eye vari-location 3 dimensional image input devices, single eye mono-locaion 3 dimensional image input devices, ultrasound 3 dimensional image input devices, general 3 dimensional object input device

8. the claim of 1, wherein the said vari-focal lens means is composed of the group selected from piezo-electric lens, lens with motion generator, mechanical lens, deformable lens, acousto-optic lens, electro-optic lens, lenses that changes the focus with control

9. the claim of 1, wherein the said object-projector position controller means is composed of the group selected from base height/position controller, projector height/position controller, tank height/position controller, micro-display height/position controller.

10. the matrix light unit device composed of the group selected from
1) elementary unit means
2) base frame means
3) Optionally controller means

11. the claim of 10, wherein said elementary unit means is composed of the group selected from surface material unit designed to change the height, locaion and/or angle relative to the base frame means in order to deflect the incoming beam to right direction. The material can be reflective or non-reflective. It can be silicon or other materials.

11. the claim of 10, wherein said elementary unit means is composed of the group selected from surface material unit designed to change the height, locaion and/or angle relative to the base frame means in order to deflect the incoming beam to right direction. The material can be reflective or non-reflective. It can be silicon or other materials. This is used for optical images generation and/or object generation and/or optical patterning of neural computer.

13. the claim of 10, wherein said base frame means is composed of the group selected from the base that support the elementary unit means. This can be stable or movable.

14. the claim of 10, wherein said controller means is composed of the group selected from the controlling system to control each element of said elementary unit means and optionally base frame means
